(19) United States
(12) Patent Application Publication
(10) Pub. No.: US 2014/0188601 A1
(43) Pub. Date: Jul. 3, 2014

(54) INTEGRATION BETWEEN BRICK-AND-MORTAR ESTABLISHMENTS AND WEB BASED ESTABLISHMENTS

(71) Applicant: INTERNATIONAL BUSINESS MACHINES CORPORATION, Armonk, NY (US)

(72) Inventors: Knut I. Buset, Chicago, IL (US); Blaine H. Dolph, Western Springs, IL (US); Sri Ramanathan, Lutz, FL (US); Tom Somboonsong, Allentown, PA (US); Matthew B. Trevathan, Kennesaw, GA (US)

(73) Assignee: INTERNATIONAL BUSINESS MACHINES CORPORATION, Armonk, NY (US)

(21) Appl. No.: 13/733,663

(22) Filed: Jan. 3, 2013

(51) Int. Cl. G06Q 30/06

(52) U.S. Cl. CPC G06Q 30/0633
USPC 705/14.49; 705/26.8; 705/26.7

(57) ABSTRACT

Approaches are provided for quick response (QR) code and barcode based integration between brick-and-mortar stores and web store fronts. Specifically, an approach is provided that is implemented in a computer infrastructure having computer executable code tangibly embodied on a computer readable storage medium having programming instructions operable to determine whether an item is in inventory at a physical location of a user, one or more alternate locations, or an on-line store of a merchant, by leveraging a scanned SQ code or bar code of the item. The program instructions are operable to add the item to a virtual cart associated with a mobile device of a user based on the scanned SQ code or bar code. The program instructions are operable to complete an order of the item at one of the physical location of the user, the one or more alternate locations, and the on-line store of a merchant.

### FIELD OF THE INVENTION

The invention relates to computer systems and, more particularly, to systems and methods for quick response (QR) code and barcode based integration between brick-and-mortar establishments and web based establishments.

### BACKGROUND

Many retailers are not able to seamlessly integrate their web presence to their brick-and-mortar establishments. More specifically, in many cases, a web campaign cannot be attributed to an in-store purchase. In other cases, the retailer may have items which are out of stock items and thus cannot fulfill a user's order in a current brick-and-mortar establishment (also referred to as a local store); however, the retailer may be able to fulfill the order through an on-line presence, e.g., a retailer's on-line store, or an alternate store. The retailer, however, does not have the ability to integrate the local store's inventory with the on-line store's inventory or the alternate store's inventory.

Retailers also lack the ability to address the speed at which a consumer can check out the user's items of purchase. Although many retailers have implemented self checkout lanes, consumers still need to scan each item at the register. As a result, a significant amount of the consumer's time is taken up scanning and bagging items, which can be time consuming and cumbersome.

Accordingly, there exists a need in the art to overcome the deficiencies and limitations described hereinabove.

### SUMMARY

In a first aspect of the invention, a method for completing a retail purchase includes: determining, by a computer processor, whether an item is in inventory at a physical location of a user, one or more alternate locations, or an on-line store of a merchant, by leveraging a scanned SQ code or bar code of the item; adding, by the computer processor, the item to a virtual cart associated with a mobile device of a user based on the scanned SQ code or bar code; and completing, by the computer processor, an order of the item at one of the physical location of the user, the one or more alternate locations, and the on-line store of a merchant.

In another aspect of the invention, system is implemented in hardware including a computer processor, includes a commerce engine configured to: maintain a virtual cart of items; generate a quick response (QR) code based on items within the virtual cart; determine whether the items within the virtual cart are in current inventory at a current location of a consumer, at another location or offered on-line by a merchant; complete an order of a consumer based on which items are within the virtual cart and are in current inventory at the current location of the consumer, at the another location or offered on-line by the merchant; and a recommendation engine configured to identify one or more items omitted from a physical in-store cart but found to be in the inventory at the another location or offered on-line by the merchant.

In an additional aspect of the invention, a computer program product is provided for completing a retail purchase. The computer program product includes: one or more computer-readable, tangible storage devices; program instructions, stored on at least one of the one or more storage devices, to determine that a product to be purchased is available in a retailer's inventory at one of a current location of a user, another location and at a virtual, on-line store by leveraging a scanned code of the product; program instructions, stored on at least one of the one or more storage devices, to add the product to a virtual cart for purchase; program instructions, stored on at least one of the one or more storage devices, to notify the user of the location of the product when it is not at the current location of the user; and program instructions, stored on at least one of the one or more storage devices, to fulfill the order by either automatically shipping the product to the user from the another location or the virtual, on-line store or requesting the user to pick up the product.

In a further aspect of the invention, a computer system is provided for completing a retail purchase. The system includes: one or more processor, one or more computer-readable memories and one or more computer-readable, tangible storage devices; program instructions, stored on at least one of the one or more storage devices for execution by at least one of the one or more processor via at least one of the one or more memories, to check an availability of a product in a retailer's inventory; program instructions, stored on at least one of the one or more storage devices for execution by at least one of the one or more processor via at least one of the one or more memories, to send a confirmation that a product is available in the retailer's inventory at a current location of a user, another location or at a virtual, on-line store; program instructions, stored on at least one of the one or more storage devices for execution by at least one of the one or more processor via at least one of the one or more memories, to complete a user's order based on a location of the product as found by leveraging a scanned code of the product; and program instructions, stored on at least one of the one or more storage devices for execution by at least one of the one or more processor via at least one of the one or more memories, to receive recommendations which identify one or more products to purchase and which are provided at a specific location, including the another location or at a virtual or the on-line store.

In yet another aspect of the invention, a method is provided for deploying a system for a retail purchase. The method includes providing a computer infrastructure. The computer infrastructure is operable to receive confirmation that a product is available in a retailer's inventory at one of a current location of a user, another location or at a virtual, on-line store. The computer infrastructure is further operable to place the product in a virtual cart. The computer infrastructure is further operable to complete a user's order based on a weight difference between a user's in-store cart and the virtual cart. The weight difference is a difference between an actual weight of the user's in-store cart and an expected weight of the user's in-store cart based on the virtual cart. The computer infrastructure is further operable to receive recommendations which identify one or more products omitted from the user's in-store cart.

### BRIEF DESCRIPTION OF THE SEVERAL VIEWS OF THE DRAWINGS

The present invention is described in the detailed description which follows, in reference to the noted plurality of drawings by way of non-limiting examples of exemplary embodiments of the present invention.

FIG. 1 shows an illustrative environment for implementing steps in accordance with aspects of the present invention.

FIG. 2 shows multiple front end systems in communication with multiple back end systems in accordance with aspects of the present invention.

FIG. 3 shows an exemplary swim lane diagram in accordance with aspects of the present invention.

FIG. 4 shows an exemplary swim lane diagram in accordance with aspects of the present invention.

FIG. 5 shows an exemplary swim lane diagram in accordance with aspects of the present invention.

### DETAILED DESCRIPTION

The invention relates to computer systems and, more particularly, to systems and methods for QR code and barcode based integration between brick-and-mortar establishments and web based establishments. The present invention addresses multiple problems that retailers experience, i.e., problems with on-line attribution, mixed fulfillment, and inefficient checkouts. For example, in embodiments, by leveraging a QR code or barcode (that identifies an item (also referred to as a product)), the user can purchase any product, regardless of whether such product is stocked in the brick-and-mortar establishment or provided on-line or at another location. That is, by example, when the product is not in stock in the brick-and-mortar establishment or has a low inventory level, the user can be forwarded directly to the merchant's on-line presence, e.g., virtual store, in order to purchase such product. The product can then be placed in a user's virtual shopping cart for check-out and purchase. In embodiments, by using the QR code or barcode, all products which are physically present in the merchant's brick-and-mortar establishment can also be placed in the virtual shopping cart, for purposes of efficient check out and purchase of such products.

The present invention maintains the virtual cart which is associated to the user's mobile device while they shop in a merchant's brick and mortar establishment. In embodiments, the virtual cart is filled by scanning QR codes or bar codes. The QR code or bar code can be used to search for inventory in the store, search for inventory in nearby stores, and search online inventory for a particular product. The QR code can be anything from a phone number to a URL to freeform text, a bar code, etc. The QR code could be placed in a product and the end-user would simply snap a picture of the QR code to place an item in their virtual cart.

In embodiments, the present invention provides systems and processes for maintaining track of items purchased by the user. The tracking of such items, using the virtual cart, for example, can be maintained regardless of whether the item is available in the store, in the on-line environment or at another location. Furthermore, in accordance with aspects of the present invention, by leveraging the QR code or barcode, the user can search a retailer's inventory in the local store, an inventory in alternate stores, and/or an on-line inventory for a particular product. In this way, by leveraging the QR code or barcode, the user can reserve items in other stores, including the on-line store. More specifically, when the user scans the QR code or barcode of an item, the systems and processes of the present invention can determine that such item is a low inventory item or is unavailable, and automatically allow the user to choose to have the item shipped directly to the user via the merchant's on-line presence, or picked up in a different store. In this way, the user can complete their entire purchase at one store, but have the items shipped via the on-line store or picked up at an alternate store.

In addition, the systems and processes of the present invention can provide promotions by further leveraging the QR code or barcode. For example, if an item is filled via an on-line fulfillment due to the store's inventories being low or not in stock, the processes and systems of the present invention can provide discounts or other promotional items for any inconveniences encountered by the user. These promotional items can also be offered via a different channel, e.g., through the local store, or on-line presence. To this end, in embodiments, when the user scans a QR code or barcode to place an item in the virtual cart, the systems and/or processes can determine any promotions which cross sell or up sell other related products.

Furthermore, by using the virtual cart of the present invention, an item can be validated during checkout in order to more efficiently and quickly allow the user to purchase such items. For example, when an item is placed in the virtual cart, its weight can automatically be tabulated via known look-up tables. At checkout, the items provided in the physical cart can be validated by weighing the physical items in the physical cart and comparing this to a known, calculated weight of all of the items in the virtual cart. By subtracting the weight of the physical items from the known, calculated weight, the processes of the present invention can infer which items are not in the physical cart and either automatically ship such items to the user or direct the user to another location for picked-up at an alternate location. In this way, the present invention can identify one or more items that are omitted from the physical cart based on a difference between the weight of the items in the cart and the total weight of the items in the virtual cart.

Additionally, in embodiments of the present invention, the systems and/or processes can determine a location of the user and prompt the user to complete the order using a web application. More specifically, when the user leaves a local store, the systems and/or processes can prompt the user to complete the order using the web application. The systems and/or methods can further prompt the user to complete the order using the retailer's on-line store or pick-up the items at an alternate store.

### System Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM),an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

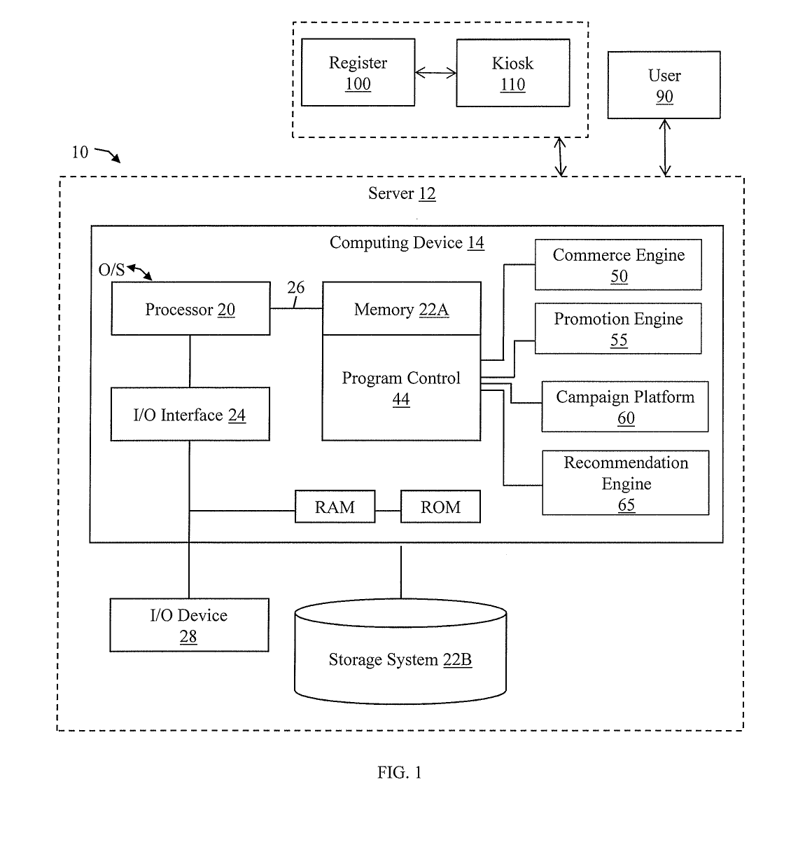

FIG. 1 shows an illustrative environment 10 for managing the processes in accordance with the invention. To this extent, environment 10 includes a server or other computing system 12 that can perform the processes described herein. In particular, server 12 includes a computing device 14. The computing device 14 can be resident on a network infrastructure or computing device of a third party service provider (any of which is generally represented in FIG. 1).

The computing device 14 also includes a processor 20, memory 22A, an I/O interface 24, and a bus 26. The memory 22A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 14 is in communication with an external I/O device/resource 28 and a storage system 22B. For example, I/O device 28 can include any device that enables an individual to interact with computing device 14 (e.g., user interface) or any device that enables computing device 14 to communicate with one or more other computing devices using any type of communications link. The external I/O device/resource 28 may be for example, a handheld device, PDA, handset, keyboard etc.

In general, processor 20 executes computer program code (e.g., program control 44), which can be stored in memory 22A and/or storage system 22B. Moreover, in accordance with aspects of the invention, program control 44 controls a commerce engine 50, a promotion engine 55, a campaign platform 60, and a recommendation engine 65, which are configured to perform the processes described herein. In embodiments, a user 90 can communicate with commerce engine 50, promotion engine 55, campaign platform 60, and/or recommendation engine 65 through computing device 14 and/or server 12, either directly or remotely through server 12 or computing device 14. The computing device 14 and/or server 12 can also communicate with a register 100 or a kiosk 110, at a merchant's brick and mortar establishment. In embodiments, user 90 can access or communicate with commerce engine 50, promotion engine 55, campaign platform 60, and/or recommendation engine 65 using a mobile device, e.g., a mobile application.

In implementation, the user's mobile device can be used to scan or obtain QR codes and barcodes in order to place items in a virtual cart. In embodiments, the QR code can leverage, i.e., parse, a product SKU that is passed as a name value pair into commerce engine 50. Also, a mobile application, e.g., user's mobile device, could leverage a freeform text based on XML that will contain the URL for the web service being called in any parameters that need to be prefilled for the service. In embodiments, commerce engine 50 can also obtain user supplied parameters that may be obtained from the user's wireless device, e.g., mobile device, or directly from the user such as the user's login credentials or unique ID of the wireless device including phone number. In this way, commerce engine 50 can automatically parse and determine particular users of the system.

If available in the local store, items can also be placed in a physical cart; whereas, items that are not available will be placed only in the virtual cart using commerce engine 50. In embodiments, the virtual cart can include any items which are requested for purchase and which are provided in the merchant's virtual store, e.g., on-line, as determined by commerce engine 50. In embodiments, the virtual cart can be maintained by commerce engine 50. The commerce engine 50 can also maintain stock-keeping units (SKUs) and other information pertinent to products, e.g., prices.

The commerce engine 50 can also determine whether items in the user's virtual cart will be fulfilled through the local store purchase, pick-up at a different location, and/or through an on-line order. This can be done via several methods. By way of one non-limiting example, commerce engine 50 can determine which items are not available in the store, and whether such items are available through the merchant's on-line presence or at another location. If the item is available through the merchant's on-line presence or at another location, the commerce engine can place such item(s) in the virtual cart for purchase at the present location, but either request such items be shipped through the merchant's on-line presence or by another location (or alternatively picked up by the user at the other location). By way of another non-limiting example, commerce engine 50 can determine which items are not available in the store by determining a total weight of the user's virtual cart, and comparing such weight to the items in the physical cart. In this way, commerce engine 50 can determine which items are missing from the physical cart, and prompt user 90 to have the missing items picked-up at another location or shipped directly to user 90, via the merchant's on-line presence.

In more specific embodiments, during checkout, user 90 can weigh the items in the in-store cart, and commerce engine 50 can validate the order based on a weight comparison between the in-store cart and the virtual cart. For example, in embodiments, commerce engine 50 can determine which items are missing from the physical, in-store cart by making a comparison of items in the virtual cart and the physical cart, and through a look-up table, determine which items may be missing from the physical, in-store cart. More specifically, by knowing (i) the weight of each item in the virtual cart and (ii) the total weight of the items in the physical cart, commerce engine 50 can determine which items are omitted from the physical cart by referring to a look-up table in storage system 22B, and through a simple additive calculation determine which items are missing from the physical cart. Once this is determined, commerce engine 50 can verify such missing items with the user and either instruct the user to pick-up the items at an alternate location or allow the user to request shipment directly to the user. In embodiments, the commerce engine 50 can also forward the user directly to the merchant's on-line presence for purchases of items through the virtual cart, based on the SQ code or barcode of items within the physical store. The commerce engine 50 can also handle market-based pricing or other pricing options that are important to the retailer.

In further embodiments, the present invention can be used to quickly and efficiently checkout user 90 at register 100 or kiosk 110, based on the QR code or bar code that is called up and/or displayed automatically on register 100 or kiosk 110. In this way, the items in the virtual cart can be provided directly to register 100 or kiosk 110.

Additionally, promotion engine 55 can provide promotions to a user. For example, in non-limiting embodiments, promotion engine 55 can cross-sell or up-sell products related to items in the virtual cart. This can be determined based on a correlation between the scanned QR code or barcode and other items provided in a database, e.g., storage system 22B. In addition, or alternatively, promotion engine 55 can send user 90 a promotional item via the on-line store after the user has purchased items in the local store, e.g., a user can purchase items in-store and receive another, promotional item not offered or unavailable in the store. The promotion engine 55 can also provide discount pricing, free shipping, etc., to user 90 based on a predetermined criteria, e.g., a purchase exceeds a certain price threshold or amount of products, a item not in the store, or inconvenience encountered by the user. Moreover, promotion engine 55 can notify user 90 that they qualify for a promotion because one or more product(s) is not available or the store's inventory is low, thereby incentivizing the user to fulfill the order via an on-line store or pick-up at another location.

The campaign platform 60 can be used to provide targeted advertisements to the users. More specifically, in embodiments, campaign platform 60 can be used to analyze the virtual cart and provide advertisements to user 90 based on products already in the virtual cart.

Moreover, recommendation engine 65 can provide recommendations to user 90 regarding the purchase of different, similar, or alternate items. Furthermore, recommendation engine 65 can provide recommendations of which items may be missing from the virtual or physical cart. For example, based a weight difference between the in-store cart and virtual cart, recommendation engine 65 can provide recommendations to the user describing which item(s) may be missing from the user's in-store cart. More specifically, recommendation engine 65 can conduct iterative processes to identify which item(s) constitutes the weight difference between the virtual cart and the in-store cart, and based on such analysis, identify a single item or combination of items which are of the weigh difference. It should be understood by those of ordinary skill in the art the present invention can identify any weight difference and any measurement unit, e.g., English and metric units. In embodiments, recommendation engine 65 identifies which of the one or more items omitted from the physical in-store cart are in inventory at the another location or offered on-line by the merchant and provides a recommendation to purchase such items.

The commerce engine 50, promotion engine 55, campaign platform 60, and recommendation engine 65 can be implemented as one or more program code in program control 44 stored in memory 22A as separate or combined modules. Additionally, commerce engine 50, promotion engine 55, campaign platform 60, and recommendation engine 65 may be implemented as separate dedicated processors or a single or several processors to provide the function of these tools. While executing the computer program code, processor 20 can read and/or write data to/from memory 22A, storage system 22B, and/or I/O interface 24. The program code executes the processes of the invention. The bus 26 provides a communications link between each of the components in computing device 14.

The computing device 14 can include any general purpose computing article of manufacture capable of executing computer program code installed thereon (e.g., a personal computer, server, etc.). However, it is understood that computing device 14 is only representative of various possible equivalent-computing devices that may perform the processes described herein. To this extent, in embodiments, the functionality provided by computing device 14 can be implemented by a computing article of manufacture that includes any combination of general and/or specific purpose hardware and/or computer program code. In each embodiment, the program code and hardware can be created using standard programming and engineering techniques, respectively.

Similarly, computing infrastructure 12 is only illustrative of various types of computer infrastructures for implementing the invention. For example, in embodiments, server 12 includes two or more computing devices (e.g., a server cluster) that communicate over any type of communications link, such as a network, a shared memory, or the like, to perform the process described herein. Further, while performing the processes described herein, one or more computing devices on server 12 can communicate with one or more other computing devices external to server 12 using any type of communications link. The communications link can include any combination of wired and/or wireless links; any combination of one or more types of networks (e.g., the Internet, a wide area network, a local area network, a virtual private network, etc.); and/or utilize any combination of transmission techniques and protocols.

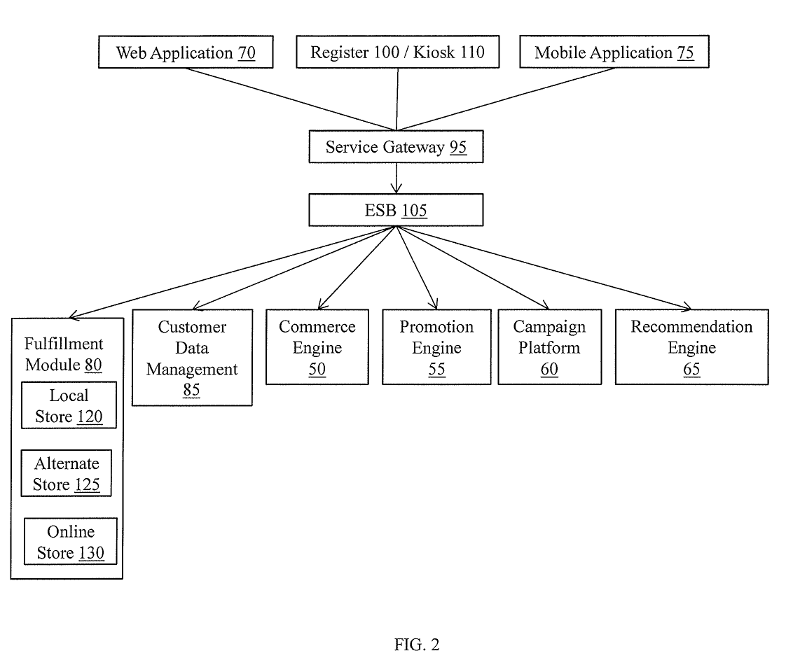

FIG. 2 shows multiple frontend systems in communication with multiple backend systems in accordance with aspects of the present invention. More specifically, FIG. 2 shows multiple frontend systems, e.g., a web application 70, mobile application 75, and register 100/kiosk 110, communicating with multiple backend systems, e.g., a fulfillment module 80, a customer data management database 85, commerce engine 50, promotion engine 55, and/or campaign platform 60, via a service gateway 95 and an enterprise service bus (ESB) 105. In embodiments, any of the engines of FIG. 1 may be provided in the back end system.

In embodiments, fulfillment module 80 monitors and maintains information related to a retailer's inventory. For example, fulfillment module 80 can store information related to an inventory of a local store 120, inventories at one or more alternate locations 125, and an inventory of an on-line store 130. In this way, the present invention follows a multi-fulfillment commerce implementation. That is, user 90 can look up inventory at multiple locations, including local store 120, alternate store(s) 125, or on-line store 130 via fulfillment module 80 and/or through commerce engine 50 (or other engines).

In embodiments, customer data management database 85 stores information related to user 90. For example, customer data management database 85 can store a user profile including authentication information and/or user preferences. The customer data management database 85 can also be used to store past order information and/or incomplete purchase orders, such that these orders can be easily reinstated. In embodiments, customer data management database 85 can be storage system 22B of FIG. 1.

Moreover, according to aspects of the present invention, ESB 105 can be used to choreograph the processes described herein. More specifically, ESB 105 allows multiple channels an ability to leverage campaign platform 60/promotion engine 55 and/or manage a virtual cart in commerce engine 50. To this end, ESB 105 and service gateway 95 facilitate communications between mobile application 75, the retailer, and the back-end systems, i.e., fulfillment module 80, customer data management database 85, commerce engine 50, promotion engine 55, and campaign platform 60. As a result, the frontend systems and backend systems work in conjunction with QR codes or barcodes to create a more integrated user experience across multiple channels.

### Flow Diagrams

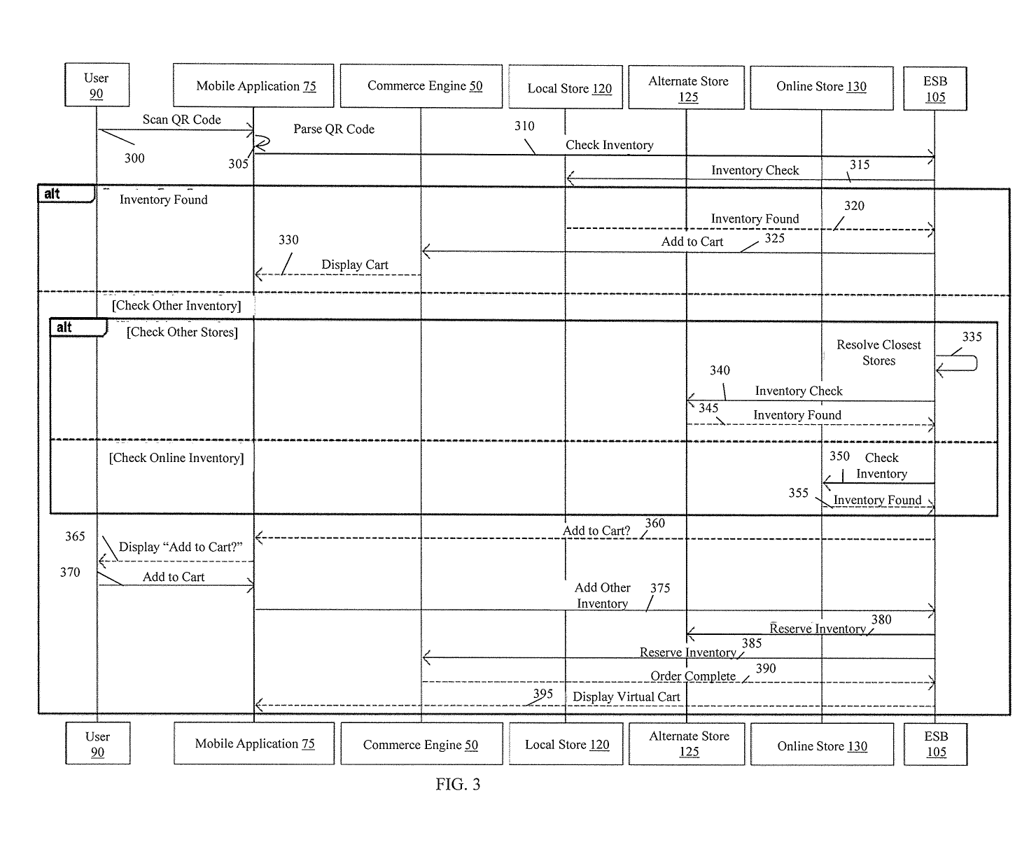

FIGS. 3-5 show exemplary flows for performing aspects of the present invention. The steps of FIGS. 3-5 may be implemented in the environment of FIG. 1, for example. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, the invention can take the form of a computer program product accessible from a computer-usable or computer-readable medium providing program code for use by or in connection with a computer or any instruction execution system. The software and/or computer program product can be implemented in the environment of FIG. 1. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

FIG. 3 depicts an exemplary swim lane diagram showing processing steps in accordance with aspects of the present invention. The More specifically, FIG. 3 shows a flow for a process of using mobile application 75 in order to add products to a user's virtual cart by scanning QR codes or barcodes of items in a brick-and-mortar establishment. The exemplary swim lane diagram of FIG. 3 has seven players: user 90, mobile application 75, commerce engine 50, a local store 120, an alternate store 125, an on-line store 130 and ESB 105.

As shown in FIG. 3, for example, the systems and processes of the present invention can parse items to place in the virtual cart, and the virtual cart is maintained by the commerce engine. This allows a central repository, e.g., storage system, 22B, to maintain product weights, SKUs, prices, and other information pertinent to the product while maintaining a list of products of interest to the user, similar to the way an e-commerce engine handles a shopping cart on the web. The systems and processes of the present invention maintain the virtual cart that is associated to the user's mobile device while they shop within the merchant's brick and mortar establishment. The virtual cart is filled by scanning QR codes. A user may place a real item in their physical shopping cart while keeping a tab of items in the in the virtual cart that may or may not be available in the store. The systems and processes of the present invention allow the user to take a picture of a QR code, search for inventory in the store, search for inventory in nearby stores, and search online inventory for a particular product. The user can reserve items in other stores, including the online store, so the user can purchase all products at one store and have them either shipped via the online store or pick them up at a nearby store. When the user scans the QR code, the user can choose an option have the product shipped or pick up a different store.

In embodiments, when a user adds an item to the virtual cart, the user may send unique information that identifies the user with the virtual cart. A virtual cart itself may only be valid for a specified amount of time which we will call the cart session. Each time the user adds or removes an item from the cart by a QR code, for example, the cart session is reset to allow the user to continue shopping. If the user's virtual cart has timed out, it can be reinstated at which time the user may be presented with the option to shift all items to a drop ship order. This would allow the user to purchase items from previous visits, while continuing the shopping experience.

More specifically, at step 300, user 90 can scan a QR code or barcode with mobile application 75. At step 305, mobile application 75 can parse the QR code or barcode as should be understood by those of ordinary skill art. At step 310, mobile application 75 communicates with ESB 105 in order to request an availability of the item associated with the scanned QR code or barcode, and at step 315, ESB 105 checks the inventory of the local store 120.

At step 320, local store 120 can notify ESB 105 that the item is in stock, and at step 325, ESB 105 adds the item to the virtual cart. In embodiments, the virtual cart can be maintained by commerce engine 50, for example. At step 330, the virtual cart can be displayed to user 90 using mobile application 75. In embodiments, the present invention can be used to maintain the user's virtual cart while user 90 continues to shop in the store.

At step 335, ESB 105 can identify one or more alternate stores 125 when the item is unavailable or inventory is low at local store 120, and at step 340, ESB 105 can also check an inventory of the one or more identified alternate stores 125. At step 345, identified alternate stores 125 can notify ESB 105 that the requested product is available. Alternatively, or in addition to checking alternate stores 125, at step 350, ESB 105 can also check an inventory of on-line store 130, and at step 355, on-line store 130 can notify ESB 105 that the item is available. At step 360, ESB 105 can send an “Add to Cart?” message to mobile application 75, which can be displayed to user 90 at step 365. In this way, at step 370, user 90 can select to complete the order at local store 120, pick-up the item at one of alternate stores 125, or have the order fulfilled by on-line store 130, e.g., ship the item directly to user 90. The completion of the order can include providing the user with a purchase price of the items in any combination of the virtual cart and physical cart and/or purchase such items.

At step 375, mobile application 75 can be used to notify ESB 105 that user 90 selected to pick-up the product at alternate store 125 or to have the order fulfilled by on-line store 130. At step 380, ESB 105 can notify alternate store 125 to reserve the item for user 90. In embodiments, the user can reserve items in other stores, including the online store, so the user can purchase the products at one store and have them either shipped via the online store or picked up at a nearby store. In embodiments, when the user scans the QR code or barcode, the user can choose an option have the product shipped or pick up a different store.

In addition, at step 385, ESB 105 can also notify commerce engine 50 to add the item to the virtual cart when the item is being picked-up at alternate store 125 or being shipped to user 90 by on-line store 130. After the item has been added to the virtual cart, at step 390, commerce engine 50 can notify ESB 105 that the order is complete, and at step 395, ESB 105 can display the virtual cart to user 90. It should be understood by those of skill in the art that if the users virtual cart has timed out, the processes and systems of the present invention have the ability to reinstate the virtual cart. For example, during the reinstatement process, the user may be presented with the option to shift all items to a drop ship order. This would allow the user to purchase items from previous visits that he or she may not have, while continuing to shop.

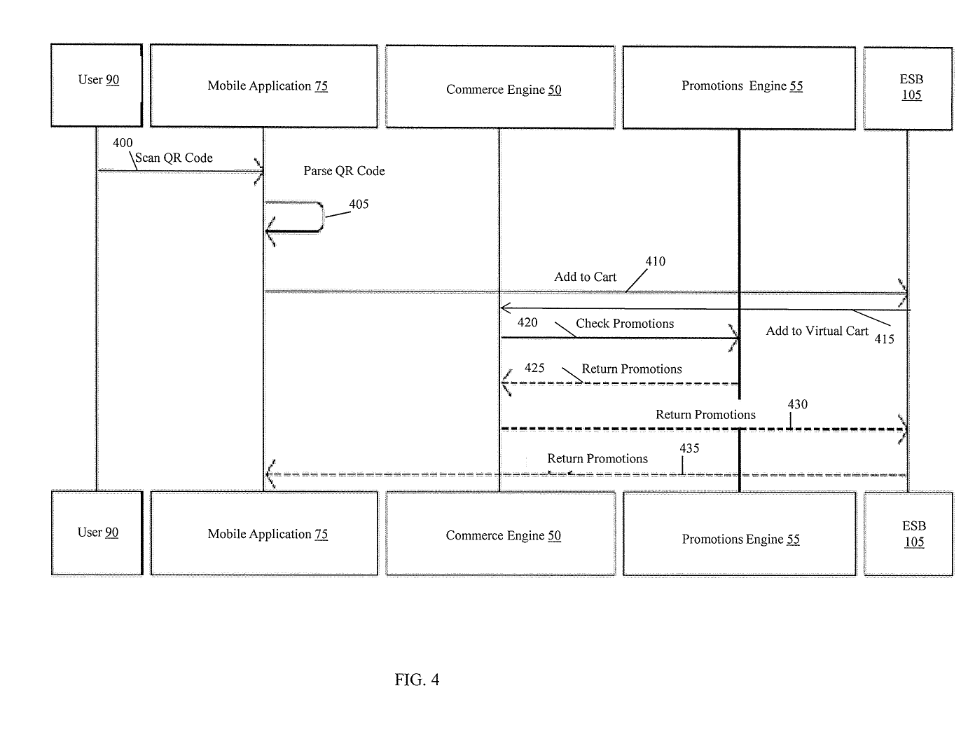

FIG. 4 depicts an exemplary swim lane diagram showing processing steps in accordance with aspects of the present invention. The exemplary swim lane diagram of FIG. 4 has five players: user 90, mobile application 75, commerce engine 50, promotions engine 55 and ESB 105. In this alternative approach, ESB 105 may receive a low inventory return from the store's inventory system. At such time in the process, the promotions engine would be notified of such low inventor, and will determine there are any promotions that would incentivize the end-user have to items shipped. If the user decides to have the item shipped, such item can be marked as a shipped item within their virtual cart.

More specifically, FIG. 4 shows a process of providing promotions to user 90 using a promotion engine 55. At step 400, user 90 can scan a QR code or barcode of an item in a brick-and-mortar establishment using mobile application 75. At step 405, mobile application 75 can parse the QR code or barcode as should be understood by those of ordinary skill art. At step 410, mobile application 75 can communicate with ESB 105 to add the item to the virtual cart, and at step 415, ESB 105 can add the item to the virtual cart, as described herein with respect to FIG. 3.

At step 420, commerce engine 50 can communicate with promotion engine 55 to determine whether user 90 is eligible for any promotions. For example, in non-limiting embodiments, promotion engine 55 can cross-sell or up-sell products related to items in the virtual cart, send user 90 a promotional item via on-line store 130 after the user has purchased products in local store 120, provide discount prices, free shipping, etc., to user 90, and/or notify user 90 that they qualify for a promotion because one or more product(s) is unavailable or the inventory at local store 120 is low. At steps 425 and 430, promotion engine 55 can return the promotions to commerce engine 50 which, in turn, sends promotion to ESB 105. In embodiments, promotion engine 55 can return the promotions directly to ESB 105. At step 435, the promotions can be displayed to user 90 using mobile application 75.

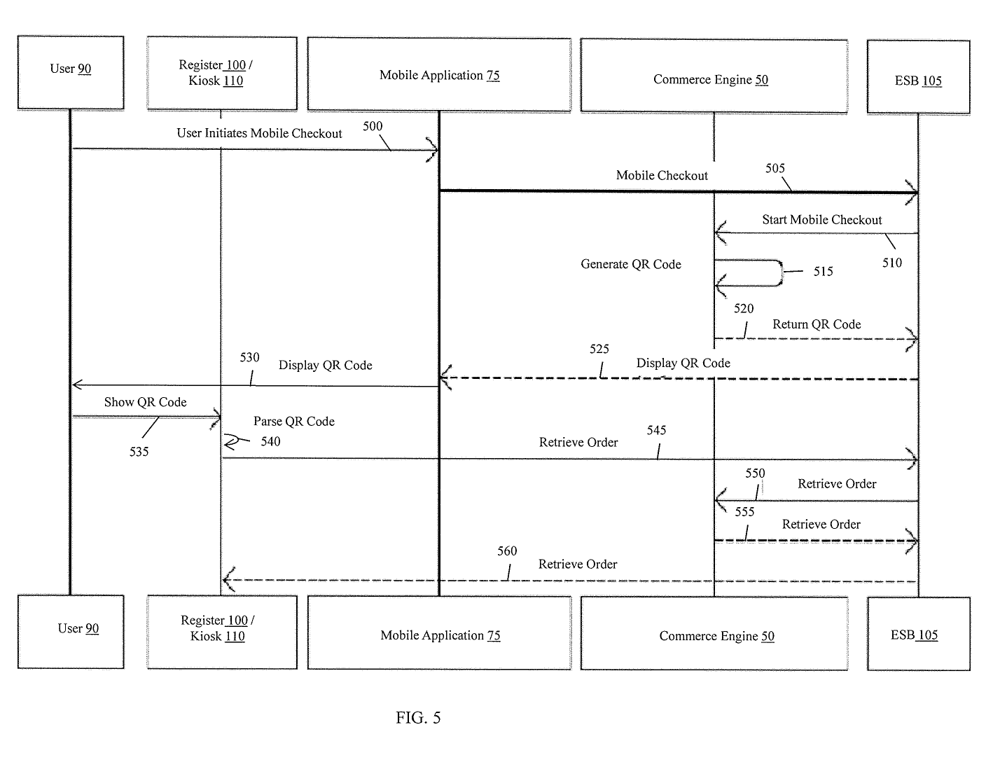

FIG. 5 depicts an exemplary swim lane diagram showing processing steps in accordance with aspects of the present invention. More specifically, FIG. 5 shows a process of completing a checkout. The exemplary swim lane diagram of FIG. 5 has five players: user 90, register 100/kiosk 110, mobile application 75, commerce engine 50, and ESB 105.

At step 500, user 90 may initiate a mobile checkout using a mobile application 75, and at step 505, mobile application 75 can notify ESB 105 of the checkout. At step 510, ESB 105 can communicate with commerce engine 50 to start the mobile checkout. At step 515, commerce engine 50 can generate a QR code, which, at step 520, can be returned to ESB 105. At step 525,

ESB 105 can send the generated QR code to mobile application 75, which, at step 530, can be displayed to user 90 using mobile application 75. At step 535, user 90 can display the generated QR code to register 100/kiosk 110. In embodiment, register 100 may be a self-checkout register or live cashier. At step 540, register 100/kiosk 110 can parse the generated QR code, and at step 545, register 100/kiosk 110 can communicate with ESB 105 to retrieve the order. At step 550, ESB 105 can communicate with commerce engine 50 in order to retrieve order, e.g., the virtual cart. Additionally, at steps 555 and 560, commerce engine 50 can return the order to register 100/kiosk 110 using ESB 105. In this way, user 90 can complete the transaction as described herein, e.g., based on a weight comparison of the in-store cart and the virtual cart.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for completing a retail purchase, the method comprising:
determining, by a computer processor, whether an item is in inventory at a physical location of a user, one or more alternate locations, or an on-line store of a merchant, by leveraging a scanned SQ code or bar code of the item;
adding, by the computer processor, the item to a virtual cart associated with a mobile device of a user based on the scanned SQ code or bar code; and
completing, by the computer processor, an order of the item at one of the physical location of the user, the one or more alternate locations, and the on-line store of a merchant.

2. The method of claim 1, wherein the scanned QR code is parsed and thereafter checked to determine that the item associated with the QR code is in inventory at the physical location of the user, the one or more alternate locations, or the on-line store of a merchant.

3. The method of claim 2, wherein the adding of the item to the virtual cart is performed after it is determined that the item is in inventory.

4. The method of claim 2, further comprising providing promotions to the user based on the scanned SQ code or bar code.

5. The method of claim 4, wherein the promotions comprise at least one:
determining to cross-sell or up-sell products related to the item in the virtual cart;
sending a user a promotional item via an on-line store after the user has purchased the item;
providing discount prices or free shipping to the user based on a predetermined criteria; and
notifying the user that the user qualifies for a promotion when one or more products is not available or inventory at the physical location of the user.

6. The method of claim 1, wherein the completing the order comprising providing a purchase price to the user based on items in the virtual cart.

7. The method of claim 1, wherein the programming instructions are further operable to determine which items are omitted from a physical cart.

8. The method of claim 7, wherein determining which items are omitted from the physical cart comprises:
determining a weight of the items in the physical cart;
calculating a total weight of the items in the virtual cart;
subtracting the determined weight from the calculated weight to determine a weight difference; and
reviewing a look up table of all items and through an iterative process determining which one or more items in the look-up amount to the weight difference.

9. The method of claim 8, further comprising providing recommendations to the user, which identify an item or combination thereof which constitute the weight difference and the identified items omitted from the physical cart are selected for an on-line fulfillment or pick-up at an alternate store.

10. The method of claim 9, further comprising providing targeted advertisements to the user based on items already in the virtual cart.

11. The method of claim 1, wherein steps of claim 1 are provided by a service provider on a subscription, advertising, and/or fee basis.

12. A system implemented in hardware comprising a computer processor, comprising:
a commerce engine configured to:
maintain a virtual cart of items;
generate a quick response (QR) code based on items within the virtual cart;
determine whether the items within the virtual cart are in current inventory at a current location of a consumer, at another location or offered on-line by a merchant;
complete an order of a consumer based on which items are within the virtual cart and are in current inventory at the current location of the consumer, at the another location or offered on-line by the merchant; and
a recommendation engine configured to identify one or more items omitted from a physical in-store cart but found to be in the inventory at the another location or offered on-line by the merchant.

13. The system of claim 12, wherein the commerce engine determines which items are omitted from a physical in-store cart by a weight difference between items in the virtual cart and items determined to be in the physical in-store cart.

14. The system of claim 13, wherein the weight difference is found by:
determining a weight of the physical in-store cart;
calculating a weight of the items to be purchased and which are within the virtual cart;
determining a difference between the weight of the physical in-store cart and the calculated weight; and
viewing one or more items that would account for the weight difference.

15. The system of claim 14, wherein the recommendation engine identifies which of the one or more items omitted from the physical in-store cart are in inventory at the another location or offered on-line by the merchant and provides a recommendation to purchase such items.

16. The system of claim 12, wherein the commerce engine is further configured to retrieve an order based on the generated QR code.

17. The system of claim 12, wherein the commerce engine is further configured to:
determine a location of a user desiring to purchase the items; and
prompt the user to complete an order through an on-line store or an alternate store.

18. The system of claim 12, further comprising a promotion engine which is operable to at least one:
determine cross-selling or up-selling items related to the items in the virtual cart;
send a user a promotional item via an on-line store after a user has purchased the items in current location of the user;
provide discount prices or free shipping to the user based on a predetermined criteria; and
notify the user that the user qualifies for a promotion when one or more items are not available at the current location of the user.

19. A computer program product for completing a retail purchase, the computer program product comprising:
one or more computer-readable, tangible storage devices;
program instructions, stored on at least one of the one or more storage devices, to determine that a product to be purchased is available in a retailer's inventory at one of a current location of a user, another location and at a virtual, on-line store by leveraging a scanned code of the product;
program instructions, stored on at least one of the one or more storage devices, to add the product to a virtual cart for purchase;
program instructions, stored on at least one of the one or more storage devices, to notify the user of the location of the product when it is not at the current location of the user; and
program instructions, stored on at least one of the one or more storage devices, to fulfill the order by either automatically shipping the product to the user from the another location or the virtual, on-line store or requesting the user to pick up the product.

20. The computer program product of claim 19, further comprising program instructions, stored on at least one of the one or more storage devices, to notify a service provider that the product is available at one of the current location of the user, the another location and at the virtual, on-line store.

21. The computer program product of claim 19, further comprising program instructions, stored on at least one of the one or more storage devices, to provide a promotion to the user when the product is at another location or at the virtual, on-line store.

22. A computer system for completing a retail purchase, the system comprising:
one or more processor, one or more computer-readable memories and one or more computer-readable, tangible storage devices;
program instructions, stored on at least one of the one or more storage devices for execution by at least one of the one or more processor via at least one of the one or more memories, to check an availability of a product in a retailer's inventory;
program instructions, stored on at least one of the one or more storage devices for execution by at least one of the one or more processor via at least one of the one or more memories, to send a confirmation that a product is available in the retailer's inventory at a current location of a user, another location or at a virtual, on-line store;
program instructions, stored on at least one of the one or more storage devices for execution by at least one of the one or more processor via at least one of the one or more memories, to complete a user's order based on a location of the product as found by leveraging a scanned code of the product; and
program instructions, stored on at least one of the one or more storage devices for execution by at least one of the one or more processor via at least one of the one or more memories, to receive recommendations which identify one or more products to purchase and which are provided at a specific location, including the another location or at a virtual or the on-line store.

23. The computer system of claim 22, wherein the program instructions to receive recommendations provide a recommendation based on items omitted from a physical shopping cart.

24. A method of deploying a system for a retail purchase, comprising:
providing a computer infrastructure, being operable to:
receive confirmation that a product is available in a retailer's inventory at one of a current location of a user, another location or at a virtual, on-line store;
place the product in a virtual cart;
complete a user's order based on a weight difference between a user's in-store cart and the virtual cart, wherein the weight difference is a difference between an actual weight of the user's in-store cart and an expected weight of the user's in-store cart based on the virtual cart; and
receive recommendations which identify one or more products omitted from the user's in-store cart.
